(19) United States
(12) Patent Application Publication
(10) Pub. No.: US 2025/0269895 A1
(43) Pub. Date: Aug. 28, 2025

(54) STEERING APPARATUS FOR VEHICLE

(71) Applicant: HYUNDAI MOBIS CO., LTD., Seoul (KR)

(72) Inventor: Jong Seon LIM, Yongin-si (KR)

(73) Assignee: HYUNDAI MOBIS CO., LTD., Seoul (KR)

(21) Appl. No.: 19/004,663

(22) Filed: Dec. 30, 2024

(30) Foreign Application Priority Data
Feb. 27, 2024 (KR) 10-2024-0028255

(51) Int. Cl. B62D 1/19; B62D 5/04

(52) U.S. Cl. CPC B62D 5/0421; B62D 5/0454

(57) ABSTRACT

A steering apparatus for a vehicle including a housing, a worm wheel secured inside the housing and mounted on a steering shaft, a worm shaft operably engaged with the worm wheel to rotate, a bearing mounted on the worm shaft, and a damper rotatably surrounds the bearing and elastically presses the bearing to allow the worm shaft to engage with the worm wheel.

### CROSS-REFERENCE TO RELATED APPLICATION

This application claims priority from and the benefit under 35 U.S.C. § 119 of Korean Patent Application No. 10-2024-0028255, filed on Feb. 27, 2024, in the Korean Intellectual Property Office, the entire disclosure of which is incorporated by reference for all purposes.

### BACKGROUND

### Technical Field

Exemplary embodiments of the present disclosure relate to a steering apparatus for a vehicle and, more particularly, to a steering apparatus for a vehicle capable of preventing tilting and noise of a worm shaft.

### Description of the Related Art

In a conventional steering apparatus, components such as a spring, sliding damper, and end cover assembly are configured in a lower bearing to compensate for the rotation and tilting of a worm shaft when the worm shaft and worm wheel are driven. The axial distance between the worm wheel and the worm shaft is not consistently maintained, causing the worm shaft to tilt depending on a pressure angle as the worm shaft rotates. The tilting of the worm shaft increases rattle noise and friction, and also causes the generation of abnormal noise when the worm shaft tilts more than a desired tilt amount. Therefore, these issues require improvement.

The related art of the present disclosure is disclosed in Korean Patent No. 10-2261787 (registered on Jun. 1, 2021 and entitled “STEERING APPARATUS FOR VEHICLE”).

### SUMMARY

Various embodiments of the present disclosure are directed to a steering apparatus for a vehicle capable of preventing tilting and noise of a worm shaft.

A steering apparatus for a vehicle according to the present disclosure includes: a housing, a worm wheel configured to be housed inside the housing and be mounted on a steering shaft, a worm shaft configured to be engaged with the worm wheel to rotate; a bearing configured to be mounted on the worm shaft, and a damper configured to rotatably surround the bearing and elastically press the bearing to allow the worm shaft to engage with the worm wheel.

In an embodiment, the damper may include a cover configured to close the open housing and an elastic part configured to extend from the cover, elastically press the bearing, and allow the worm shaft to engage with the worm wheel.

In an embodiment, the elastic part may include an elastic body configured to be spaced apart from the cover and surround the bearing, a connection configured to connect the cover and the elastic body, and an elastic arm configured to be mounted on the elastic body and provide an elastic force to the bearing while being elastically deformed upon contact with the bearing.

In an embodiment, the connection may connect the elastic body to the cover in a cantilever shape.

In an embodiment, the elastic body may include an elastic body guide configured to be spaced apart from the cover and surround the bearing and an elastic cutout configured to be cut into the elastic body guide and allow the elastic body guide to be elastically deformed when in contact with the bearing.

In an embodiment, the elastic body may further include an elastic movement path configured to be formed to pass through an inner surface of the elastic body guide and provide a path for the bearing elasticity providing part to move when in contact with the bearing.

In an embodiment, the elastic part may further include an O-ring configured to be mounted on an outer surface of the elastic body and be elastically deformed when in contact with an inner surface of the housing.

In an embodiment, a plurality of the O-rings may be mounted along the longitudinal direction of the elastic body.

In an embodiment, the elastic body may include an O-ring mount groove concave along a circumferential direction of the elastic body, and the O-ring may be mounted in the O-ring mount groove.

In an embodiment, the elastic part may further include a reinforcing part configured to connect the cover and the connection.

With the steering apparatus for a vehicle of the present disclosure, the tilting and noise of the worm shaft may be prevented by the damper.

In addition, with the steering apparatus for a vehicle, the tilting of the worm shaft is controlled by a single damper, which reduces the number of components and simplifies an assembly process, thereby reducing manufacturing costs and improving productivity.

### BRIEF DESCRIPTION OF THE DRAWINGS

FIG. 1 is a schematic perspective view of a steering apparatus for a vehicle according to an embodiment of the present disclosure.

FIG. 2 is a schematic assembled perspective view of a steering apparatus for a vehicle according to an embodiment of the present disclosure.

FIG. 3 is a schematic perspective view of a damper from one direction according to an embodiment of the present disclosure.

FIG. 4 is a schematic perspective view of a damper from the other direction according to an embodiment of the present disclosure.

FIG. 5 is a schematic side view of a damper according to an embodiment of the present disclosure.

FIG. 6 is a schematic side sectional view taken along line A-A of FIG. 5.

FIG. 7 is a schematic side sectional view showing a state before an operation of a bearing and a worm shaft mounted in a damper of a steering apparatus for a vehicle according to an embodiment of the present disclosure.

FIG. 8 is a schematic side sectional view showing an operation of a bearing and a worm shaft mounted in a damper of a steering apparatus for a vehicle according to an embodiment of the present disclosure.

FIG. 9 is an enlarged partial side sectional view schematically showing B of FIG. 8.

### DETAILED DESCRIPTION

Embodiments of a steering apparatus for a vehicle according to the present disclosure will be described hereinafter with reference to the accompanying drawings. For clarity and convenience in description, thicknesses of lines, sizes of constituent elements, and the like may be illustrated in exaggerated proportions in the drawings.

In addition, the terms used below are defined in consideration of the functions thereof in the present disclosure and may vary depending on the intention of a user or an operator or common practice. Therefore, these terms should be contextually defined in light of the present specification.

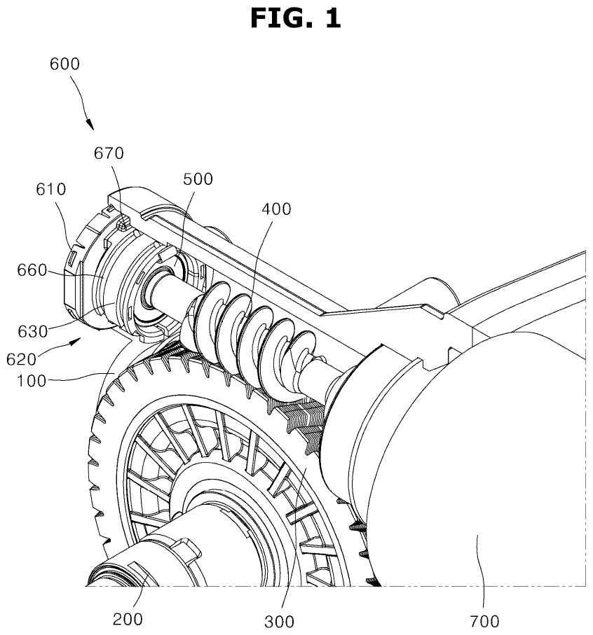

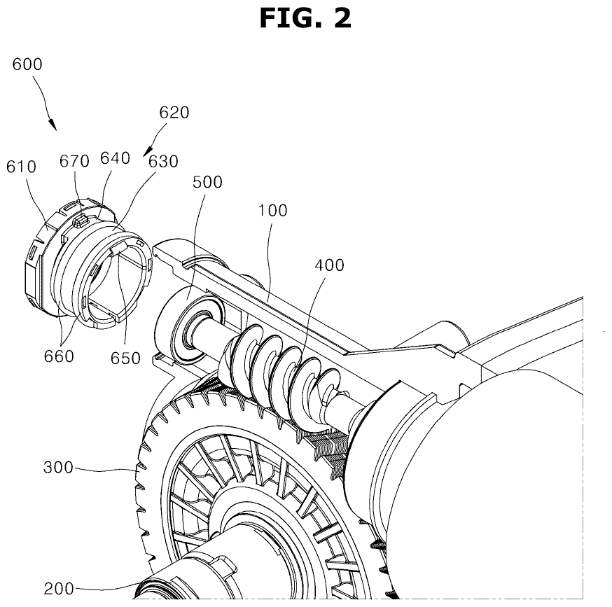

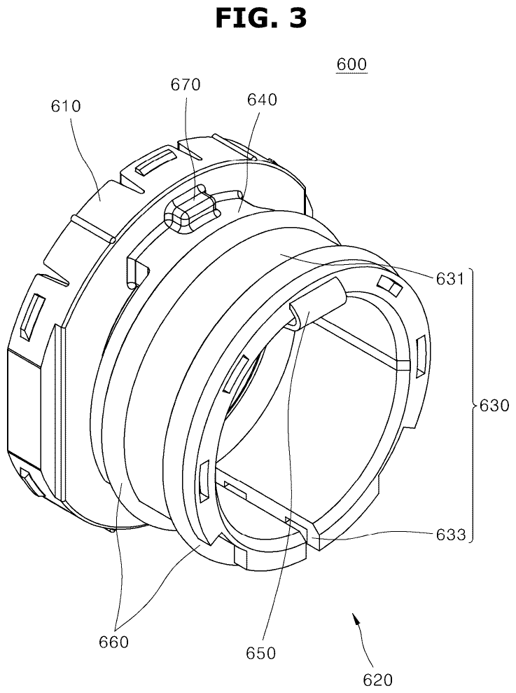

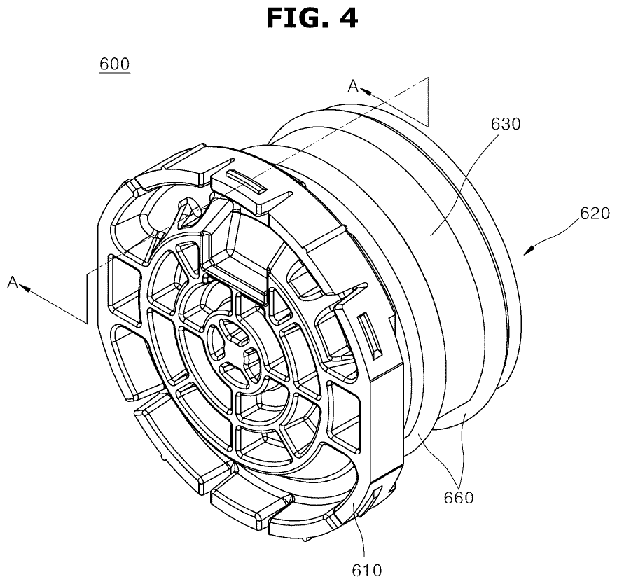

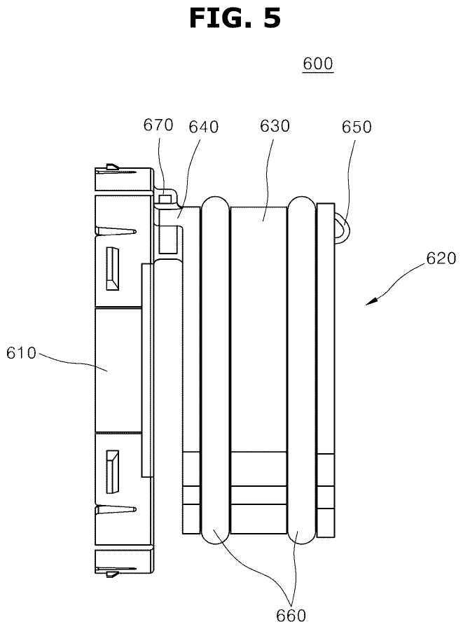

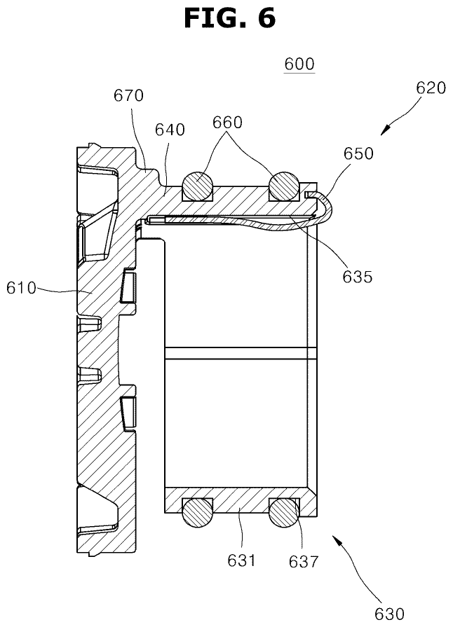

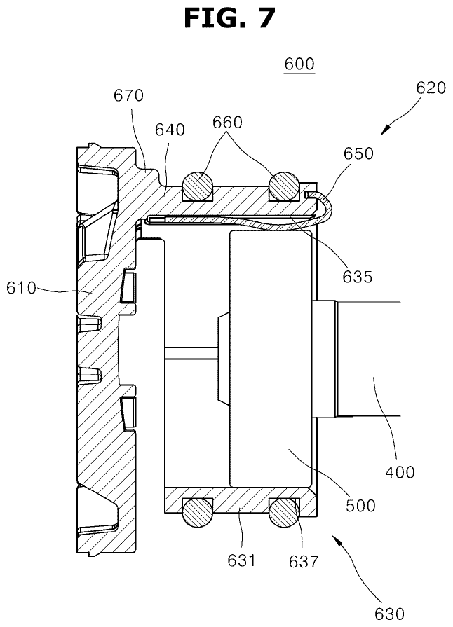

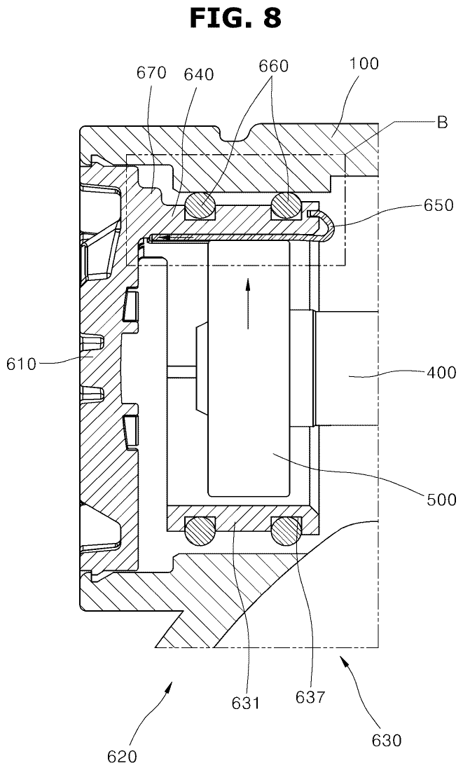

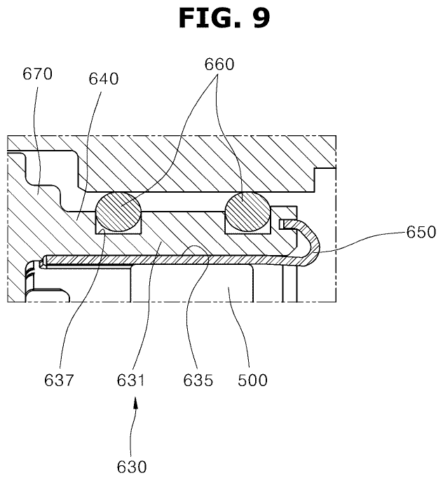

FIG. 1 is a schematic perspective view of a steering apparatus for a vehicle according to an embodiment of the present disclosure. FIG. 2 is a schematic assembled perspective view of a steering apparatus for a vehicle according to an embodiment of the present disclosure. FIG. 3 is a schematic perspective view of a damper from one direction according to an embodiment of the present disclosure. FIG. 4 is a schematic perspective view of a damper from the other direction according to an embodiment of the present disclosure. FIG. 5 is a schematic side view of a damper according to an embodiment of the present disclosure. FIG. 6 is a schematic side sectional view taken along line A-A of FIG. 5. FIG. 7 is a schematic side sectional view showing a state before operation of a bearing and a worm shaft mounted in a damper of a steering apparatus for a vehicle according to an embodiment of the present disclosure. FIG. 8 is a schematic side sectional view showing an operation of a bearing and a worm shaft mounted in a damper of a steering apparatus for a vehicle according to an embodiment of the present disclosure. FIG. 9 is an enlarged partial side sectional view schematically showing B of FIG. 8.

Referring to FIGS. 1 to 9, a steering apparatus for a vehicle according to an embodiment of the present disclosure may include a housing 100, a steering shaft 200, a worm wheel 300, a worm shaft 400, a bearing 500, and a damper 600.

Inside the housing 100, the steering shaft 200, the worm wheel 300, the worm shaft 400, the bearing 500, and the damper 600 may be mounted. The housing 100 may be formed with one side (left side in FIGS. 1 and 2) open, and the damper 600 may be mounted to the open housing 100.

The steering shaft 200 may be connected to a steering wheel of a vehicle. The worm wheel 300 may be housed inside the housing 100 and be mounted on the steering shaft 200.

The worm shaft 400 may be engaged with the worm wheel 300 to rotate. The worm shaft 400, engaged with the worm wheel 300 to rotate, may be axially connected to a motor 700. The motor 700 may be connected to one side (right side in FIG. 1) of the worm shaft 400, and a ring-shaped bearing 500 may be mounted on the other side (left side in FIG. 1) of the worm shaft 400.

The bearing 500 may be mounted on an end (left end in FIG. 1) of the worm shaft 400. The bearing 500 may be mounted on the end of the worm shaft 400 to rotatably support the worm shaft 400 and reduce friction generated by the rotation of the worm shaft 400.

The damper 600 may rotatably surround the bearing 500 and elastically press the bearing 500 to allow the worm shaft 400 to engage with the worm wheel 300. The damper 600 may elastically press the bearing 500 to direct the worm shaft 400 toward the worm wheel 300, thereby preventing or reducing tilting and noise of the worm shaft 400.

The damper 600 may include a cover 610 and an elastic part 620. The cover 610 may close one side (left side in FIG. 1) of the open housing 100. The cover 610 may close the open housing 100 to prevent the entry of foreign substances into the housing 100.

The elastic part 620 may extend from the cover 610, elastically press the bearing 500, and allow the worm shaft 400 to engage with the worm wheel 300. The elastic part 620 may include an elastic body 630, a connection 640, and an elastic arm 650.

The elastic body 630 may be spaced apart from the cover 610 and surround the bearing 500. The elastic body 630 may be formed in a ring shape to surround the bearing 500.

The elastic body 630 may include an elastic body guide 631 and an elastic cutout 633. The elastic body guide 631 may be spaced apart from the cover 610 and surround the bearing 500. The elastic body guide 631 may be formed in a ring shape to surround the bearing 500. The elastic body guide 631 may be formed with one side (lower side in FIG. 3) open.

The elastic cutout 633 may be cut into one side (lower side in FIG. 3) of the elastic body guide 631 and allow the elastic body guide 631 to be elastically deformed when in contact with the bearing 500.

When assembled into the housing 100, the elastic part 620 may absorb lateral clearance with the bearing 500 as the elastic body guide 631 contracts laterally due to the elastic cutout 633.

After contraction, an internal shape of the elastic body guide 631 may maintain an elliptical shape, thereby preventing or reducing an up-and-down tilt of the bearing 500.

The elastic body 630 may further include an elastic movement path 635. The elastic movement path 635 may be formed to pass through an inner surface of the elastic body guide 631 and provide a path for the bearing elasticity providing part 650 to move when in contact with the bearing 500. The elastic movement path 635 may provide a path along which one end (left end in FIG. 6) of the bearing elasticity providing part 650 may move, and prevent the bearing elasticity providing part 650 from disengaging. The elastic movement path 635 may be formed in a size that allows the bearing elasticity providing part 650 to move.

The elastic body 630 may further include an O-ring mount groove 637. The O-ring mount groove 637 may be concave along the circumferential direction of the elastic body guide 631. An O-ring 660 may be mounted in the O-ring mount groove 637. The O-ring 660 may be mounted in the O-ring mount groove 637, thereby preventing the O-ring 660 from disengaging. The number of O-ring mount grooves 637 may match the number of O-rings 660.

The connection 640 may connect the cover 610 and the elastic body 630. The connection 640 may be connected to a portion of the cover 610 on one side (left side in FIG. 5) and to a portion of the elastic body 630 on the other side (right side in FIG. 5). The connection 640 may connect the elastic body 630 to the cover 610 in a cantilever shape. The elastic body guide 631 of the elastic body 630 may be connected to the cover 610 in a cantilever shape by the connection 640, and may be elastically deformed by the bearing 500 tilting up and down.

The bearing elasticity providing part 650 may be mounted on the elastic body 630 and provide an elastic force (elastic restoring force) to the bearing 500 while being elastically deformed upon contact with the bearing 500. One side (right side in FIG. 6) of the bearing elasticity providing part 650 may be fixed to the elastic body guide 631 of the elastic body 630. The other side (left side in FIG. 6) of the bearing elasticity providing part 650 may be movably inserted into the elastic movement path 635 of the elastic body 630. A portion of the surface (lower surface in FIG. 6) of the bearing elasticity providing part 650 may be exposed from the elastic movement path 635 of the elastic body 630 and come into contact with the bearing 500.

The bearing elasticity providing part 650 may be elastically deformed when in contact with the bearing 500 that moves due to the worm shaft 400 tilting up and down. The exposed lower surface of the bearing elasticity providing part 650 may be compressed in contact with the bearing 500, and the other side of the bearing elasticity providing part 650 may be moved in the elastic movement path 635. The bearing elasticity providing part 650 may be made of a leaf spring.

The extent to which the bearing elasticity providing part 650 is exposed in the elastic movement path 635 of the elastic body 630 may be set depending on the amount of tilting of the bearing 500 and the worm shaft 400.

The elastic part 620 may further include the O-ring 660. The O-ring 660 may be mounted on an outer surface of the elastic body 630 and elastically deformed when in contact with an inner surface of the housing 100. The O-ring 660 may be formed in a ring shape and be mounted in the O-ring mount groove 637 of the elastic body 630.

The O-ring 660 may be elastically deformed when in contact with the inner surface of the housing 100. The O-ring 660 may prevent the entry of foreign substances and the generation of noise while being elastically deformed upon contact with the inner surface of the housing 100.

The O-ring 660 may be made of an elastically deformable material, including rubber, silicone, urethane, or the like.

A plurality of the O-rings 660 may be mounted along the longitudinal direction (right-left direction in FIGS. 5 and 6) of the elastic body 630. A plurality of the O-rings 660 may be mounted along the longitudinal direction of the elastic body guide 631 of the elastic body 630, thereby preventing the entry of foreign substances and the generation of noise.

The elastic part 620 may further include a reinforcing part 670. The reinforcing part 670 may connect the cover 610 and the connection 640. The reinforcing part 670 may connect the cover 610 and the connection 640 so that the connection between the cover 610 supported by the connection 640 and the elastic body 630 of the elastic part 620 may be stably maintained. The thickness of the reinforcing part 670 may be adjusted depending on an elastic force of the connection 640.

Referring to FIGS. 7 to 9, an operation of a steering apparatus for a vehicle according to an embodiment of the present disclosure may be described.

In FIG. 7, the bearing elasticity providing part 650 remains in contact with the bearing 500.

Referring to FIGS. 8 and 9, the bearing 500 mounted on the worm shaft 400 may be moved upward by the tilting worm shaft 400.

The bearing elasticity providing part 650 may be elastically deformed when in contact with the bearing 500 that moves due to the worm shaft 400 tilting up and down.

The bearing elasticity providing part 650 may provide an elastic force (elastic restoring force) to the bearing 500 while being elastically deformed upon contact with the bearing 500. The exposed lower surface of the bearing elasticity providing part 650 may be compressed in contact with the bearing 500, and the other side (left side in FIG. 8) of the bearing elasticity providing part 650 may be moved in the elastic movement path 635.

The bearing 500 may move downward due to the elastic restoring force of the bearing elasticity providing part 650, and the worm shaft 400 and the worm wheel 300 may maintain engagement, thereby preventing tilting and noise.

With the steering apparatus for a vehicle of the present disclosure, the tilting of the worm shaft 400 may be easily managed by the damper 600.

In addition, with the steering apparatus for a vehicle, the tilting of the worm shaft 400 may be controlled by a single damper 600, which reduces the number of components and simplifies an assembly process, thereby reducing manufacturing costs and improving productivity.

Although specific embodiments of the present disclosure have been described above, the spirit and scope of the present disclosure are not limited to these specific embodiments. Various modifications and variations are possible within the scope of not changing the gist of the present disclosure as stated in the claims by those skilled in the art to which the present disclosure pertains.

What is claimed is:

1. A steering apparatus for a vehicle comprising:
a housing;
a worm wheel is positioned inside the housing and be mounted on a steering shaft;
a worm shaft operably engaged with the worm wheel to rotate;
a bearing mounted on the worm shaft; and
a damper rotatably surrounds the bearing and elastically presses the bearing to allow the worm shaft to engage with the worm wheel.

2. The steering apparatus of claim 1, wherein the damper comprises:
a cover that is mounted on an opening of the housing; and
an elastic part is protruded from the cover, elastically presses the bearing, and allows the worm shaft to engage with the worm wheel.

3. The steering apparatus of claim 2, wherein the elastic part comprises:
an elastic body spaced apart from the cover and surrounds the bearing;
a connection to connect the cover and the elastic body; and
an elastic arm mounted on the elastic body and providing an elastic force to the bearing while being elastically deformed upon contact with the bearing.

4. The steering apparatus of claim 3, wherein the connection connects the elastic body to the cover in a cantilever shape.

5. The steering apparatus of claim 3, wherein the elastic body comprises:
an elastic body guide spaced apart from the cover and surrounds the bearing; and
an elastic cutout is cut into the elastic body guide and allows the elastic body guide to be elastically deformed when in contact with the bearing.

6. The steering apparatus of claim 5, wherein the elastic body further comprises an elastic movement path formed to pass through an inner surface of the elastic body guide and provides a path for the elastic arm to move when in contact with the bearing.

7. The steering apparatus of claim 3, wherein a plurality of O-rings are mounted along the longitudinal direction of the elastic body.

8. The steering apparatus of claim 7, wherein the elastic part further comprises an O-ring mounted on an outer surface of the elastic body and is elastically deformed when in contact with an inner surface of the housing.

9. The steering apparatus of claim 7, wherein:
the elastic body comprises an O-ring mount groove positioned along a circumferential direction of the elastic body, and
the O-ring is mounted in the O-ring mount groove.

10. The steering apparatus of claim 3, wherein the elastic part further comprises a reinforcing part to connect the cover and the connection.
